(19) United States
(12) Patent Application Publication
(10) Pub. No.: US 2007/0055621 A1
(43) Pub. Date: Mar. 8, 2007

(54) Automated method and system for predicting and/or verifying income

(75) Inventors: Howard L. Tischler, Potomac, MD (US); Chip Riordan, Columbia, MD (US); Per Gothe, San Diego, CA (US)

Correspondence Address: STERNE, KESSLER, GOLDSTEIN & FOX PLLC, 1100 NEW YORK AVENUE, N.W., WASHINGTON, DC, 20005, US

(73) Assignee: First Advantage Corporation, Columbia, MD (US)

(21) Appl. No.: 11/514,171

(22) Filed: Sep. 1, 2006

Related U.S. Application Data
(60) Provisional application No. 60/712,845, filed on Sep. 1, 2005.

(51) Int. Cl. G06Q 40/00

(52) U.S. Cl. 705/38

(57) ABSTRACT

An income predictor deploys an income model that is based on credit information obtained for a representative group of the general population. The credit information is matched against actual employment and income information to predict an income range having a specified confidence factor. The income predictor can be used by subscribers (e.g., creditors, employers, etc.) to predict and/or verify the income of a candidate (e.g., applicants, potential employees, etc.).

### CROSS-REFERENCE TO RELATED APPLICATIONS

This application claims benefit to U.S. Provisional Application No. 60/712,845, filed Sep. 1, 2005, which is incorporated herein by reference.

### BACKGROUND OF THE INVENTION

Field of the Invention

The present invention relates generally to predicting and/or verifying income.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the pertinent art(s) to make and use the invention. In the drawings, like reference numbers indicate identical or functionally similar elements. Additionally, the leftmost digit(s) of a reference number identifies the drawing in which the reference number first appears.

FIG. 1 illustrates an income predictor system.

### DETAILED DESCRIPTION OF THE INVENTION

This specification discloses one or more embodiments that incorporate the features of this invention. The embodiment(s) described, and references in the specification to “one embodiment”, “an embodiment”, “an example embodiment”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the relevant art(s) to effect such feature, structure, or characteristic in connection with other embodiments whether or not explicitly described.

An income predictor is provided for predicting and/or verifying reported income. The income predictor deploys an income model that is based on credit information obtained for a representative group of the general population. The credit information is matched against actual income (and/or employment) information to predict an income range having a specified confidence factor. The income predictor can be used by subscribers (e.g., creditors, employers, etc.) to predict and/or verify the income of a candidate (e.g., applicants, potential employees, etc.).

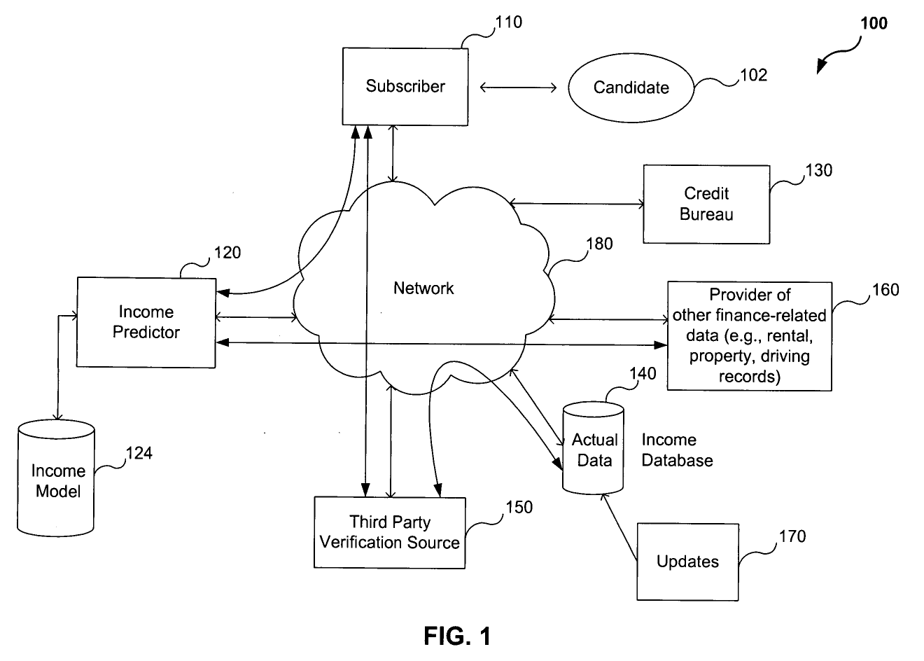

FIG. 1 illustrates an income predictor system 100 according to an embodiment of the present invention. Income predictor system 100 includes an income predictor 120 and one or more subscribers 110. A subscriber 110 can be any type of user, including a bank, mortgage company, creditor, lender, dealer, employer, law enforcement official, private investigator, government or public agency, or other party seeking income prediction and/or income verification of a candidate 102. Candidate 102 can be an individual, business entity, non-profit organization, or the like.

Subscriber 110 queries income predictor 102 to predict the income or verify reported income for candidate 102. Income predictor 102 deploys an income model 124 that is based on credit information and actual income information. Alternatively, employment information can be used in combination with income information or in place of income information. To build the income model 124, credit information is obtained from one or more credit bureaus 130. The credit information is used to develop profiles of potential candidates 102 that are based on credit histories. The credit information included in the profiles can include names, geographic/electronic addresses, identification numbers, demographics, etc. These profiles are collected together to form a sample group that is representative of the general population. The sample size (i.e., the quantity of records within income model 124) is selected to be statistically significant, or a representative sample of, an actual population having a specified confidence interval.

Upon creation of the sample group, the income model 124 is populated with actual income (and/or employment) information from an income database 140. Income database 140 can be populated and/or maintained by payroll records. In one embodiment, income database 140 may be a proprietary income verification service, such as THE WORK NUMBER® automated employment and income verifications services available from TALX Corporation (St. Louis, Mo.). The information furnished by income database 140 can be stripped of individual identity. Therefore, the profiles within income model 124 are updated by using a query key based on one or more other fields located within income database 140. These fields can include employer code, zip code, country, position/title, employee status, hire date, length of service, end date of employment, pay frequency, rate of pay, annual compensation, base pay, overtime pay, commission, bonus, other pay, and/or total pay. This list is not intended to be exhaustive, and other fields can be included. Therefore, one or more of the aforementioned fields can be used to identify a candidate 102 that is profiled within income model 124, and update the profile records to include actual employment and income information for the candidate 102.

As discussed, income database 140 includes actual income (and/or employment) information of a plurality of candidates 102. This information can be obtained from filed federal and/or state income statements, employers, financial institutions, auditors, government agencies, payroll service companies, and other sources or purveyors of income. Income database 140 receives updates 170 from these sources on a periodic basis.

Thus, income model 124 is based on credit information from one or more credit bureaus 130, and actual income (and/or employment) information from income database 140. Therefore the profiles within income model 124 are not merely based on surveys and geographic data (although this information can also be stored within income model 124). The profiles of income model 124 are based on actual income (and/or employment) information that is correlated with other information to better identify a specific candidate 102. Such other information includes country code, zip code, area code, telephone exchange, employer address, position/title, and/or the like. As a result, income model 124 provides a formula for predicting statistically significant income for a candidate 102. The records of income model 124 can be updated on a periodic basis by obtaining updated reports from credit bureau 130 and/or income database 140.

Income is predicted by income predictor 120 by applying the income model to a number of fields within a credit report received from a credit bureau and/or other reporting agencies. For example, the following fields from a credit report can be used to accurately predict a person's income: zip code, debt, size of mortgage, number of mortgages, and age. Obviously, fields can be added or deleted as would be apparent to one skilled in the art of statistics.

Income that is predicted and/or verified by income predictor 120 can also be validated by querying a third party verification source 150. Third party verification source 150 can be a proprietary income verification service, such as THE WORK NUMBER® automated employment and income verifications services available from TALX Corporation (St. Louis, Mo.). If the predicted income in income model 124 falls outside of a predefined confidence interval, the income model 124 can be updated with actual information reported from the third party verification source 150.

The services provided by income predictor 120 (as well as the records of income model 124) can also be augmented to include other finance-related data, such as property, rental, and driving records, and/or the like. Provider 160 can provide the other-finance related data.

As discussed, income predictor 120 can be used to process an application for a loan, other types of credit, employment, or the like. For example, when used to process a credit application, the predicted income returned from income predictor 120 can be compared to an income statement reported by candidate 102 on an application form. If the reported income and predicted income falls outside of a predefined tolerance range, the application can be tagged for further investigation. For instance, the predicted or reported income can be verified by querying third party verification source 150, as previously discussed, and/or tagged for manual verification. If, on the other hand, the reported and predicted income falls within the predefined tolerance range, this portion of the credit application can be approved for further processing, as appropriate.

Subscriber 110 can register to utilize the services of income predictor 120 by purchasing a subscription for a predefined term, e.g., bi-weekly, monthly, annually, etc. Subscriber 110 can also register to utilize income predictor 120 on a transactional basis. As such, subscriber 110 would pay a predefined fee for each transaction, length of a session, or the like.

Network 180 provides interconnectivity among the components of income predictor system 100. Network 180 includes wired and/or wireless local area networks (LAN) or wide area networks (WAN), such as an organization's intranet, a local internet, the global-based Internet (including the World Wide Web (WWW)), an extranet, a virtual private network, licensed wireless telecommunications spectrum for digital cell (including CDMA, TDMA, GSM, EDGE, GPRS, CDMA2000, WCDMA FDD and/or TDD or TD-SCDMA technologies), or the like. Network 180 includes wired, wireless, or both transmission media, including satellite, terrestrial (e.g., fiber optic, copper, twisted pair, coaxial, hybrid fiber-coaxial (HFC), or the like), radio, microwave, free-space optic, and/or any other form or method of transmission.

Exemplary System Implementation

FIG. 1. provides conceptual illustrations allowing an easy explanation of the present invention. It should be understood that embodiments of the present invention could be implemented in hardware, firmware, software, or a combination thereof. In such an embodiment, the various components and steps would be implemented in hardware, firmware, and/or software to perform the functions of the present invention. That is, the same piece of hardware, firmware, or module of software could perform one or more of the illustrated blocks (i.e., components or steps).

Embodiments of the invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others. Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

In this document, the terms “computer program medium” and “computer usable medium” are used to generally refer to media such as a removable storage unit, a hard disk installed in hard disk drive, and signals (i.e., electronic, electromagnetic, optical, or other types of signals capable of being received by a communications interface). These computer program products are means for providing software to a computer system. The invention, in an embodiment, is directed to such computer program products.

In an embodiment where aspects of the present invention is implemented using software, the software can be stored in a computer program product and loaded into computer system using a removable storage drive, hard drive, or communications interface. The control logic (software), when executed by a processor, causes the processor to perform the functions of the invention as described herein.

In another embodiment, aspects of the present invention are implemented primarily in hardware using, for example, hardware components such as application specific integrated circuits (ASICs). Implementation of the hardware state machine so as to perform the functions described herein will be apparent to one skilled in the relevant art(s).

In yet another embodiment, the invention is implemented using a combination of both hardware and software.

While various embodiments of the present invention have been described above, it should be understood that they have been presented by way of example, and not limitation. It will be apparent to one skilled in the relevant art(s) that various changes in form and detail can be made therein without departing from the spirit and scope of the invention. Thus, the present invention should not be limited by any of the above-described exemplary embodiments, but should be defined only in accordance with the following claims and their equivalents.

What is claimed is:

1. A method of predicting income, comprising:
creating an income model by evaluating a number of records that contain actual income information, wherein the number of records is a representative sample of an actual population;
accessing a credit report for a candidate; and
applying the income model to the credit report to generate a prediction of an income of the candidate, wherein the prediction is statistically significant.

2. The method of claim 1, further comprising:
sending the prediction to a third party for verification.

3. The method of claim 2, further comprising:
refining the income model if the prediction is not accurate based on the verification by the third party.

4. A method of approving a loan, comprising:
predicting an income of a candidate, wherein the predicting comprises:
(a) creating an income model by evaluating a number of records that contain actual income information, wherein the number of records is representative of an actual population;
(b) accessing a credit report for the candidate; and
(c) applying the income model to the credit report to generate a prediction of the income of the candidate, wherein said prediction is statistically significant;
receiving an income statement from the candidate;
comparing the income statement with the prediction to determine whether a difference between the income statement and the prediction is within a predefined tolerance; and
verifying the income statement or the prediction via a third party if the difference is greater than the predefined tolerance.

5. The method of claim 4, further comprising:
taking no further action if the difference is within the predefined tolerance.

6. A computer program product comprising a computer useable medium having computer readable program code functions embedded in said medium for causing a computer to predict income, comprising:
a first computer readable program code function that causes the computer to create an income model by evaluating a number of records that contain actual income information, wherein the number of records is representative of an actual population;
a second computer readable program code function that causes the computer to access a credit report for a candidate; and
a third computer readable program code function that causes the computer to apply the income model to the credit report to generate a prediction of an income of the candidate, wherein the prediction is statistically significant.

7. The computer program product of claim 6, further comprising:
a fourth computer readable program code function that causes the computer to send the prediction to a third party for verification.
